(19) United States
(12) Patent Application Publication
(10) Pub. No.: US 2021/0090793 A1
(43) Pub. Date: Mar. 25, 2021

(54) INDUCTOR COMPONENT AND METHOD OF MANUFACTURING INDUCTOR COMPONENT

(71) Applicant: Murata Manufacturing Co., Ltd., Kyoto-fu (JP)

(72) Inventors: Tatsuya SASAKI, Nagaokakyo-shi (JP); Shin HASEGAWA, Nagaokakyo-shi (JP); Ikuno SUGIYAMA, Nagaokakyo-shi (JP); Toshimitsu TAMURA, Nagaokakyo-shi (JP); Shinya HIRAI, Nagaokakyo-shi (JP)

(73) Assignee: Murata Manufacturing Co., Ltd., Kyoto-fu (JP)

(21) Appl. No.: 17/024,805

(22) Filed: Sep. 18, 2020

(30) Foreign Application Priority Data
Sep. 19, 2019 (JP) 2019-170636

(51) Int. Cl. H01F 27/32; H01F 27/24; H01F 41/06; H01F 41/12

(52) U.S. Cl. CPC H01F 27/32; H01F 41/12; H01F 41/06; H01F 27/24

(57) ABSTRACT

An inductor component includes an annular core; and a first coil and a second coil that are wound around the core so that winding axes thereof are parallel to each other. The first coil and the second coil each include a conductor portion and a coating that covers the conductor portion. The inductor component further includes a first insulating resin that covers at least a part of the conductor portion of the first coil, the part being exposed from the coating; and a second insulating resin that covers at least a part of the conductor portion of the second coil, the part being exposed from the coating. The first insulating resin and the second insulating resin are not connected but separated in a space between surfaces of the first coil and the second coil that face each other.

### CROSS-REFERENCE TO RELATED APPLICATION

This application claims benefit of priority to Japanese Patent Application No. 2019-170636, filed Sep. 19, 2019, the entire content of which is incorporated herein by reference.

### BACKGROUND

### Technical Field

The present disclosure relates to an inductor component and a method of manufacturing an inductor component.

### Background Art

Japanese Unexamined Patent Application Publication No. 7-58651 describes an example of an inductor component according to the related art. The inductor component includes an annular core, a first coil and a second coil that are wound around the core so as to face each other, and a mold resin that integrally seals the core and the first and second coils.

With the inductor component according to the related art, in which the mold resin integrally seals the core and the first and second coils, when magnetostriction occurs, the coil may receive stress from the surrounding mold resin, magnetic characteristics may change, and the inductance value (L-value) may decrease. Here, the term “magnetostriction” refers to a phenomenon such that the shape of a ferromagnetic body deforms when a magnetic field is applied thereto.

### SUMMARY

The present disclosure provides an inductor component and a method of manufacturing an inductor component each of which can reduce stress that a core receives from an insulating resin when magnetostriction occurs.

According to an aspect of the present disclosure, an inductor component includes an annular core; a first coil and a second coil that are wound around the core so that winding axes thereof are parallel to each other, the first coil and the second coil each including a conductor portion and a coating that covers the conductor portion; a first insulating resin that covers at least a part of the conductor portion of the first coil, the part being exposed from the coating; and a second insulating resin that covers at least a part of the conductor portion of the second coil, the part being exposed from the coating. The first insulating resin and the second insulating resin are not connected but separated in a space between surfaces of the first coil and the second coil that face each other.

With the aspect, the space between the surfaces of the first coil and the second coil face that each other is not filled with the first and second insulating resins, because the first insulating resin and the second insulating resin are not connected but separated in the space between the surfaces of the first coil and the second coil face that each other. Thus, only a portion that needs to be insulated can be insulated with the first and second insulating resins, and the amount of the first and second insulating resins can be controlled. Accordingly, stress that the core receives from the first and second insulating resins when magnetostriction occurs can be reduced.

In the inductor component according to an embodiment, the exposed part of the conductor portion of the first coil and the exposed part of the conductor portion of the second coil are positioned adjacent to an end surface of the core on one side in an axial direction of the core. The first insulating resin and the second insulating resin are positioned adjacent to the end surface of the core on the one side in the axial direction of the core; and, in the axial direction of the core, a height of each of the first insulating resin and the second insulating resin is smaller than ¼ of a height of a corresponding one of the first coil and the second coil.

With the embodiment, the amount of the first and second insulating resins can be further controlled, and stress that the core receives from the first and second insulating resins when magnetostriction occurs can be further reduced, because the height of each of the first insulating resin and the second insulating resin is smaller than ¼ of the height of a corresponding one of the first coil and the second coil in the axial direction of the core.

An inductor component according to an embodiment includes an annular core; a first coil and a second coil that are wound around the core so that winding axes thereof are parallel to each other, the first coil and the second coil each including a conductor portion and a coating that covers the conductor portion; a first insulating resin that covers at least a part of the conductor portion of the first coil, the part being exposed from the coating; and a second insulating resin that covers at least a part of the conductor portion of the second coil, the part being exposed from the coating. The exposed part of the conductor portion of the first coil and the exposed part of the conductor portion of the second coil are positioned adjacent to an end surface of the core on one side in an axial direction of the core. The first insulating resin and the second insulating resin are positioned adjacent to the end surface of the core on the one side in an axial direction of the core. In the axial direction of the core, a height of each of the first insulating resin and the second insulating resin is smaller than ¼ of a height of a corresponding one of the first coil and the second coil.

With the embodiment, only a portion that needs to be insulated can be insulated with the first and second insulating resins, and the amount of the first and second insulating resins can be controlled, because the height of each of the first insulating resin and the second insulating resin is smaller than ¼ of the height of a corresponding one of the first coil and the second coil in the axial direction of the core. Accordingly, stress that the core receives from the first and second insulating resins when magnetostriction occurs can be reduced.

In the inductor component according to an embodiment, the first insulating resin covers an outer surface of the first coil on one side in an axial direction of the core, and an end surface of the first insulating resin on one side in the axial direction of the core is flat. Also, the second insulating resin covers an outer surface of the second coil on one side in the axial direction of the core, and an end surface of the second insulating resin on one side in the axial direction of the core is flat.

With the embodiment, when mounting the inductor component on a mount substrate, the flat upper end surfaces and of the first and second insulating resins can be reliably held by suction by using a suction nozzle, because the upper end surface of the first insulating resin and the upper end surface of the second insulating resin are flat.

In the inductor component according to an embodiment, the first insulating resin does not exist on an outer surface of the first coil on the other side in the axial direction of the core, and the second insulating resin does not exist on an outer surface of the second coil on the other side in the axial direction of the core.

With the embodiment, stress that the core receives from the first and second insulating resins when magnetostriction occurs can be further reduced.

A method of manufacturing an inductor component according to an embodiment includes a step of winding a first coil and a second coil around an annular core so that winding axes thereof are parallel to each other and disposing at least a part of a conductor portion of the first coil. The part is exposed from the coating, and at least a part of a conductor portion of the second coil, and the part is exposed from the coating, adjacent to an end surface of the core on one side in an axial direction. The method further includes a step of immersing at least a part of the exposed conductor portion of the first coil and at least a part of the exposed conductor portion of the second coil into a resin bath, with the end surface of the core facing downward; and a step of forming a first insulating resin on at least the part of the exposed conductor portion of the first coil by heat curing a resin that has adhered to at least the part of the exposed conductor portion of the first coil and forming a second insulating resin on at least the part of the exposed conductor portion of the second coil by heat curing a resin that has adhered to at least the part of the exposed conductor portion of the second coil, while keeping the end surface of the core facing downward.

With the embodiment, only a portion that needs to be insulated can be insulated with the first and second insulating resins, and the amount of the first and second insulating resins can be controlled. Accordingly, stress that the core receives from the first and second insulating resins when magnetostriction occurs can be reduced.

With the inductor component and the method of manufacturing an inductor component according to aspects of the present disclosure, stress that the core receives from the insulating resin can be reduced.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is an upper perspective view of an inductor component according to an embodiment of the present disclosure;

FIG. 2 is a lower perspective view of the inductor component;

FIG. 3 is an upper perspective view of the inside of the inductor component;

FIG. 4 is an exploded perspective view of the inductor component;

FIG. 5 is a plan view of the inductor component;

FIG. 6 is a sectional view of the inductor component;

FIG. 7A illustrates a method of manufacturing an inductor component according to an embodiment of the present disclosure;

FIG. 7B illustrates the method of manufacturing an inductor component according to the embodiment of the present disclosure;

FIG. 7C illustrates the method of manufacturing an inductor component according to the embodiment of the present disclosure; and

FIG. 8 illustrates a state in which a coil is wound around a core.

### DETAILED DESCRIPTION

Hereafter, inductor components according to embodiments of the present disclosure will be described in detail with reference to the drawings. The drawings include schematic views, and dimensions and proportions in the drawings may differ from actual ones.

### First Embodiment

Configuration of Inductor Component

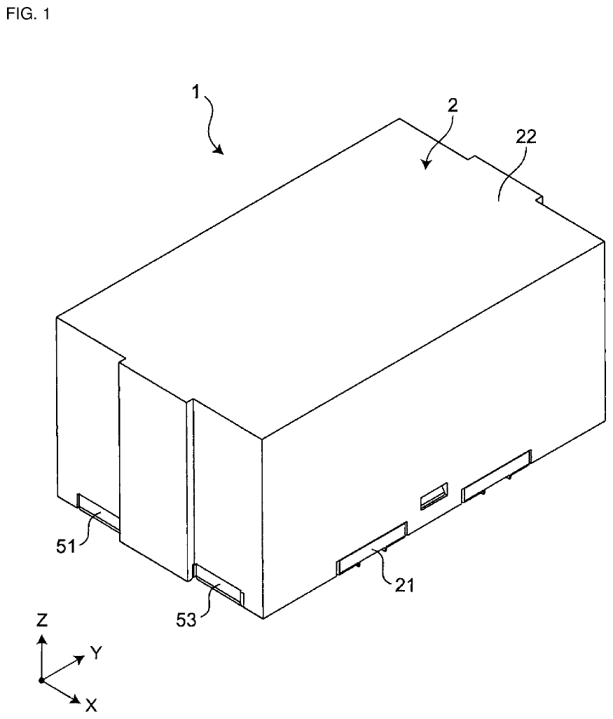

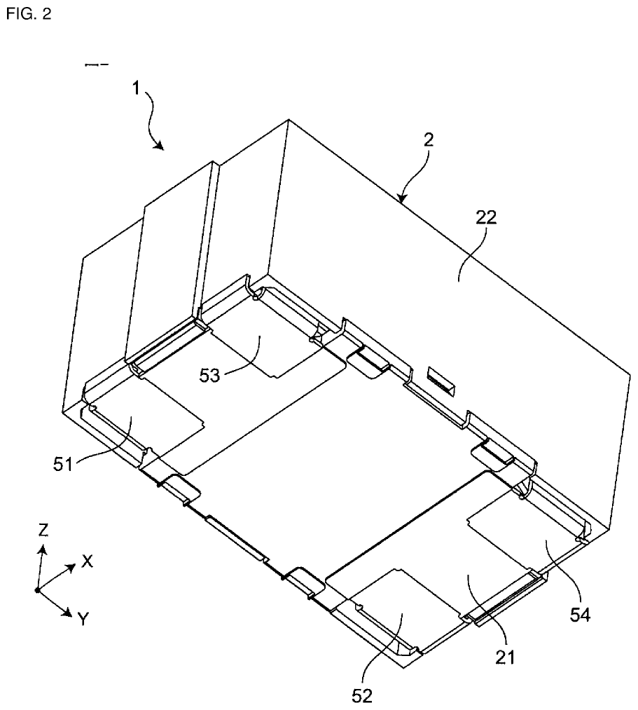

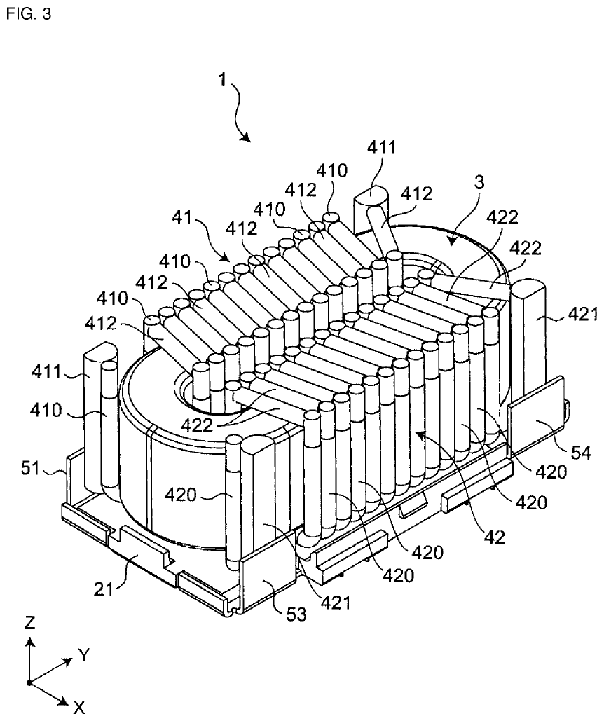

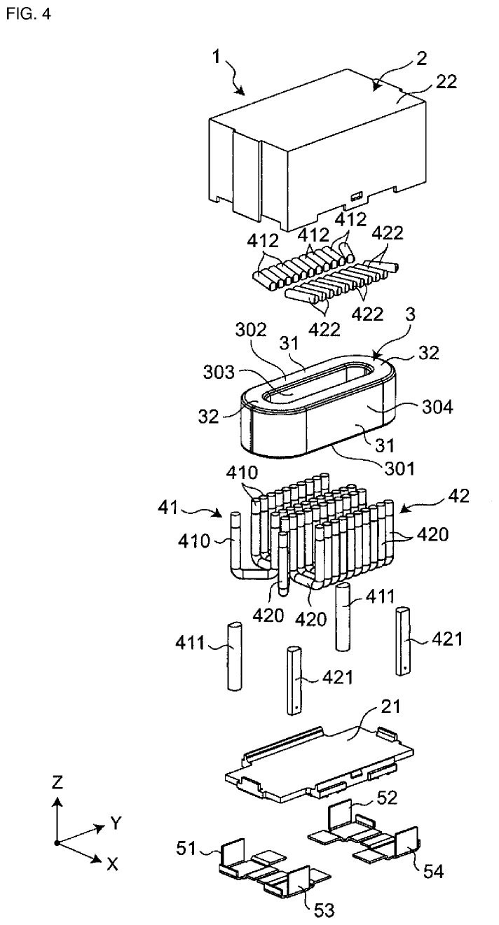

FIG. 1 is an upper perspective view of an inductor component according to a first embodiment of the present disclosure. FIG. 2 is a lower perspective view of the inductor component. FIG. 3 is an upper perspective view illustrating the inside of the inductor component. FIG. 4 is an exploded perspective view of the inductor component.

As illustrated in FIGS. 1 to 4, an inductor component 1 includes a case 2, an annular core 3 that is accommodated in the case 2, a first coil 41 and a second coil 42 that are wound around the core 3 so as to face each other, and first to fourth electrode terminals 51 to 54 that are attached to the case 2 and connected to the first coil 41 and the second coil 42. The inductor component 1 is, for example, a common-mode choke coil or the like.

The case 2 includes a bottom plate portion 21 and a cover 22 that has a box-like shape and that covers the bottom plate portion 21. The case 2 is made of a material that has strength, heat resistance, and is preferably made of a fire-retardant material. For example, the case 2 is made of a resin such as polyphenylene sulfide (PPS), liquid crystal polymer (LCP), or polyphthalamide (PPA); or ceramics. The core 3 is set on the bottom plate portion 21 so that the axis of the core 3 is perpendicular to the bottom plate portion 21. The axis of the core 3 is the axis of an inner hole of the core 3. The shape of the case 2 (the bottom plate portion 21 and the cover 22) is a quadrangle when seen in the axial direction of the core 3. In the present embodiment, the shape of the case 2 is a rectangle. Here, the transversal direction of the case 2 is defined as the X-direction, the longitudinal direction of the case 2 is defined as the Y-direction, and the height direction of the case 2 is defined as the Z-direction. When the shape of the case 2 is a square, the length of the case 2 in the X-direction and the length of the case 2 in the Y-direction are the same.

The first to fourth electrode terminals 51 to 54 are attached to the bottom plate portion 21. The first electrode terminal 51 and the second electrode terminal 52 are positioned at two corners of the bottom plate portion 21 that face each other in the Y-direction, and the third electrode terminal 53 and the fourth electrode terminal 54 are positioned at two corners of the bottom plate portion 21 that face each other in the Y-direction. The first electrode terminal 51 and the third electrode terminal 53 face each other in the X-direction, and the second electrode terminal 52 and the fourth electrode terminal 54 face each other in the X-direction.

The shape of the core 3 is an oval (track shape) when seen in the axial direction. When seen in the axial direction, the core 3 includes a pair of longitudinal portions 31 that extend along the major axis and face each other in the minor-axis direction, and a pair of transversal portions 32 that extend along the minor axis and that face each other in the major-axis direction. The shape of the core 3 may be a rectangle or an ellipse when seen in the axial direction.

The core 3 is, for example, a ceramic core made of ferrite or the like, or a magnetic core made from an iron-based powder compact or a nanocrystal foil. The core 3 has a lower end surface 301 and an upper end surface 302 that face each other in the axial direction, an inner peripheral surface 303, and an outer peripheral surface 304. The lower end surface 301 faces an inner surface of the bottom plate portion 21. The upper end surface 302 faces an inner surface of the cover 22. The core 3 is accommodated in the case 2 so that the longitudinal direction of the core 3 coincides with the Y-direction.

The shape of a cross section of the core 3 in a direction perpendicular to the circumferential direction is a rectangle. The lower end surface 301 and the upper end surface 302 are disposed perpendicular to the axial direction of the core 3. The inner peripheral surface 303 and the outer peripheral surface 304 are disposed parallel to the axial direction of the core 3. In the present specification, the term “perpendicular” refers not only to a state of being completely perpendicular but also to a state of being substantially perpendicular. The term “parallel” refers not only to a state of being completely parallel but also to a state of being substantially parallel.

The first coil 41 is wound around the core 3 between the first electrode terminal 51 and the second electrode terminal 52. One end of the first coil 41 is connected to the first electrode terminal 51. The other end of the first coil 41 is connected to the second electrode terminal 52.

The second coil 42 is wound around the core 3 between the third electrode terminal 53 and the fourth electrode terminal 54. One end of the second coil 42 is connected to the third electrode terminal 53. The other end of the second coil 42 is connected to the fourth electrode terminal 54.

The first coil 41 and the second coil 42 are wound along the major-axis direction so as to face each other in the minor-axis direction of the core 3. That is, the first coil 41 is wound around one of the longitudinal portions 31 of the core 3, and the second coil 42 is wound around the other longitudinal portion 31 of the core 3. The winding axis of the first coil 41 and the winding axis of the second coil 42 are parallel to each other. The first coil 41 and the second coil 42 are symmetric about the major axis of the core 3.

The number of turns of the first coil 41 and the number of turns of the second coil 42 are the same. The direction in which the first coil 41 is wound around the core 3 is opposite to the direction in which the second coil 42 is wound around the core 3. That is, the direction in which the first coil 41 is wound from the first electrode terminal 51 toward the second electrode terminal 52 is opposite to the direction in which the second coil 42 is wound from the third electrode terminal 53 toward the fourth electrode terminal 54.

The first to fourth electrode terminals 51 to 54 are connected so that common-mode currents flow in the first coil 41 from the first electrode terminal 51 toward the second electrode terminal 52 and flow in the second coil 42 from the third electrode terminal 53 toward the fourth electrode terminal 54, that is, the common-mode currents flow in the same direction. When a common-mode current flows in the first coil 41, a first magnetic flux due to the first coil 41 is generated in the core 3. When a common-mode current flows in the second coil 42, a second magnetic flux is generated in the core 3 in a direction such that the first magnetic flux and the second magnetic flux reinforce each other in the core 3. Therefore, the first coil 41 and the core 3, and, the second coil 42 and the core 3, each serve as an inductance component, and noise is removed from the common-mode currents.

A plurality of pin members are connected to the first coil 41 by, for example, laser welding, spot welding, solder joint, or the like. The pin members are not a printed circuit board or conductive wires but are bar-shaped members. The pin members each have rigidity and are more resistant to bending than conductive wires that are used for connection between electronic component modules. To be specific, each pin member is resistant to bending for the following reasons: the length of the pin member is shorter than the length of a circumference of each of the lower end surface 301, the upper end surface 302, the inner peripheral surface 303, and the outer peripheral surface 304 of the core 3; and, in addition, the rigidity of the pin member is high.

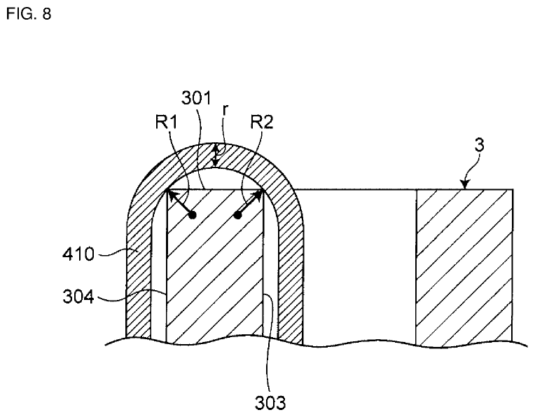

The pin members include bent pin members 410, each of which is bent in a substantially U-shape; and first and second linear pin members 411 and 412, each of which extends in a substantially linear shape. The first coil 41 includes, in order from one end to the other end, a first linear pin member 411, a plurality of sets of bent pin members 410 and second linear pin members 412, and a first linear pin member 411. The length of the first linear pin member 411 and the length of the second linear pin member 412 are different. The spring index of the bent pin member 410 is as follows: when the bent pin member 410 is wound around the lower end surface 301, the inner peripheral surface 303, and the outer peripheral surface 304 of the core 3 as illustrated in FIG. 8, at the radius of curvature R1 of the bent pin member 410 positioned at a corner of the outer peripheral surface 304 of the core 3 and at the radius of curvature R2 of the bent pin member 410 positioned at a corner of the inner peripheral surface 303 of the core 3, the spring index Ks of the bent pin member 410 is smaller than 3.6. Thus, the bent pin member 410 has high rigidity and is resistant to bending.

The bent pin members 410 and the second linear pin members 412 are alternately connected to each other by, for example, laser welding, spot welding, solder joint, or the like. One end of a second linear pin member 412 is connected to one end of a bent pin member 410, and the other end of the second linear pin members 412 is connected to one end of another bent pin member 410. By repeating this, the bent pin members 410 and the second linear pin members 412 are connected, and the bent pin members 410 and the second linear pin members 412, which have been connected, are helically wound around the core 3. That is, a set of a bent pin member 410 and a second linear pin member 412 is a unit element for one turn.

The bent pin members 410 are parallelly arranged along each of the lower end surface 301, the inner peripheral surface 303, and the outer peripheral surface 304 of the core 3. The second linear pin members 412 are parallelly arranged along the upper end surface 302 of the core 3. The first linear pin members 411 are parallelly arranged along the outer peripheral surface 304 of the core 3.

The first electrode terminal 51 is connected to one of the first linear pin members 411, and the first linear pin member 411 is connected to one end of a bent pin member 410 that is adjacent to the first linear pin member 411. The second electrode terminal 52 is connected to the other first linear pin member 411, and the first linear pin member 411 is connected to one end of a second linear pin member 412 that is adjacent to the first linear pin member 411.

The second coil 42 is composed of a plurality of pin members, as with the first coil 41. That is, the second coil 42 includes, in order from one end to the other end, a first linear pin member 421, a plurality of sets of bent pin members 420 and second linear pin members 422, and a first linear pin member 421. The bent pin members 420 and the second linear pin members 422 are alternately connected to each other and wound around the core 3. That is, the bent pin members 420 and the second linear pin members 422 are connected, and the bent pin members 420 and second linear pin members 422, which are connected, are helically wound around the core 3.

The third electrode terminal 53 is connected to one of the first linear pin members 421, and the first linear pin member 421 is connected to one end of a bent pin member 420 that is adjacent to the first linear pin member 421. The fourth electrode terminal 54 is connected to the other first linear pin member 421, and the first linear pin member 421 is connected to one end of a second linear pin member 422 that is adjacent to the first linear pin member 421.

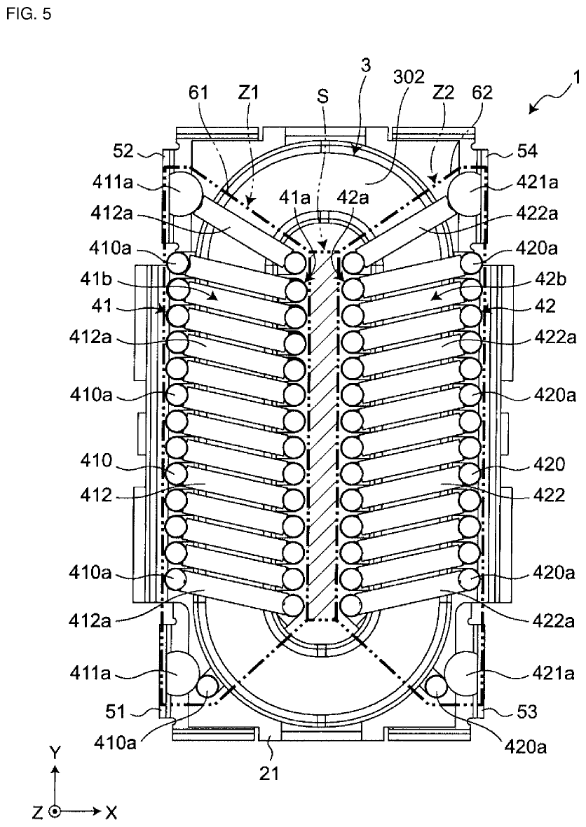

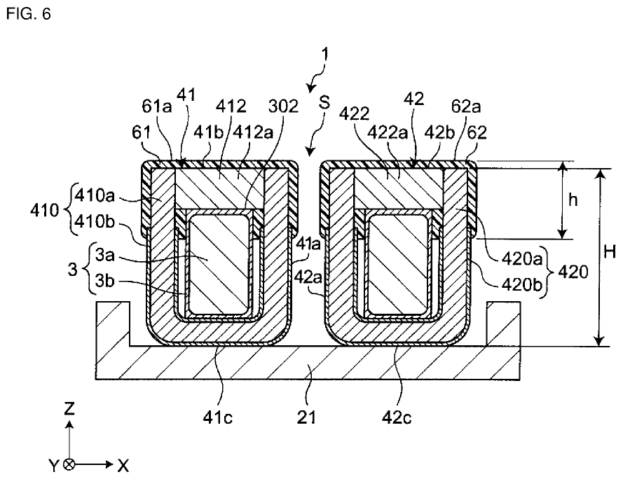

FIG. 5 is a plan view of the inductor component 1. FIG. 6 is a sectional view of the inductor component, taken along an XY plane that passes through the center of the inductor component 1 in the Y-direction. As illustrated in FIGS. 5 and 6, the first coil 41 and the second coil 42 (the pin members 410 to 412 and 420 to 422) each include a conductor portion and a coating that covers the conductor portion. The conductor portion is, for example, a copper wire, and the coating is, for example, polyamide-imide resin. The thickness of the coating is, for example, 0.02 to 0.04 mm.

To be specific, the first linear pin members 411 and 421 are conductor portions 411a and 421a that do not have coatings. The second linear pin members 412 and 422 are conductor portions 412a and 422a that do not have coatings. The bent pin members 410 and 420 are composed of conductor portions 410a and 420a and coatings 410b and 420b.

At one end and the other end of the bent pin members 410 and 420, the conductor portions 410a and 420a are exposed from the coatings 410b and 420b. That is, the first linear pin members 411 and 421, the second linear pin members 412 and 422, and the bent pin members 410 and 420 are joined to each other at the exposed conductor portions 411a and 421a, 412a and 422a, and 410a and 420a.

The inductor component 1 further includes a first insulating resin 61 that covers a part of the first coil 41 and a second insulating resin 62 that covers a part of the second coil 42. As the material of the first and second insulating resins 61 and 62, for example, a heat curing epoxy resin can be used. To be specific, the first insulating resin 61 covers at least a part of the conductor portions 411a, 412a, and 410a of the first coil 41 exposed from the coatings 410b. The second insulating resin 62 covers at least a part of the conductor portions 421a, 422a, and 420a of the second coil 42 exposed from the coatings 420b.

The first insulating resin 61 and the second insulating resin 62 are not connected but separated in a space between surfaces of the first coil 41 and the second coil 42 that face each other (facing surfaces 41a and 42a). To be specific, the facing surface 41a of the first coil 41 and the facing surface 42a of the second coil 42 are positioned at the inner peripheral surface 303 of the core 3. The space S is positioned between the facing surface 41a of the first coil 41 and the facing surface 42a of the second coil 42. The first insulating resin 61 is disposed in a first region Z1 shown in FIG. 5, and the second insulating resin 62 is disposed in a second region Z2 shown in FIG. 5. That is, the first insulating resin 61 and the second insulating resin 62 are not connected on the upper end surface 302 of the core 3. Alternatively, the first insulating resin 61 and the second insulating resin 62 may be connected on the upper end surface 302 of the core 3. That is, it is only necessary that the first insulating resin 61 and the second insulating resin 62 be separated in the space S.

With the inductor component 1, the space S is not filled with the first and second insulating resins 61 and 62, because the first insulating resin 61 and the second insulating resin 62 are not connected but separated in the space S. Thus, only a portion that needs to be insulated can be insulated with the first and second insulating resins 61 and 62, and the amount of the first and second insulating resins 61 and 62 can be controlled. Accordingly, it is possible to suppress stress that the core receives from the first and second insulating resins 61 and 62 when magnetostriction occurs, and to suppress reduction of the L-value. In contrast, with the configuration according to the related art, in which a core and first and second coils are integrally sealed with a mold resin, when magnetostriction occurs, the core may receive stress from the surrounding resin, magnetic characteristics change, and the L-value may decrease. As a comparative example, with the configuration according to the related art, in which the core, the first coil, and the second coil are integrally sealed with a mold resin, the L-value decreases by 40%. In contrast, with the present embodiment, decrease of the L-value can be reduced to only 10% or smaller.

The space S is not filled with the first and second insulating resins 61 and 62, because the first and second insulating resins 61 and 62 are not connected but separated in the space S. Thus, the creepage distance is sufficiently long, and decrease of insulation performance at a high voltage can be suppressed. Moreover, a liquid or the like does not easily accumulate in the space between the first coil 41 and the second coil 42, because the space S is present between the first coil 41 and the second coil 42. Thus, occurrence of electrochemical migration due to a voltage between the coils can be suppressed, and decrease of insulation performance at a high voltage can be suppressed. In contrast, with the inductor component according to the related art, in which the space between the first coil and the second coil is filled with the mold resin, if bubbles exist in the mold resin, surface creepage between the coils and electrochemical migration may occur in a high-voltage and high-humidity environment.

As illustrated in FIGS. 5 and 6, in a state in which the first coil 41 is formed, regarding the heights of the upper surfaces of the second linear pin members 412 in the positive Z-direction, the heights of adjacent second linear pin members 412 are the same, and the upper surfaces are parallel to the upper end surface 302 of the core 3. The same applies to the second coil 42. Thus, when curing the first and second insulating resins 61 and 62, an upper end surface 61a of the first insulating resin 61 in the positive Z-direction (on one side in the axial direction of the core 3) can be made flat, and an upper end surface 62a of the second insulating resin 62 in the positive Z-direction (on one side in the axial direction of the core 3) can be made flat.

In the state in which the first coil 41 is formed, regarding the heights of the lower surfaces of the second linear pin members 412 in the negative Z-direction, the heights of adjacent second linear pin members 412 are the same, and the lower surfaces are parallel to the upper end surface 302 of the core 3. The same applies to the second coil 42. Thus, the distance between the upper end surface 302 of the core 3 and the second linear pin members 412 can be made constant, and forming of bubbles in the first and second insulating resins 61 and 62 when curing these can be prevented.

In the state in which the first coil 41 is formed, the bent pin members 420 are parallel to the inner peripheral surface 303 and the outer peripheral surface 304 of the core 3. The same applies to the second coil 42. Thus, the distances between the bent pin members 420 and the inner peripheral surface 303 and the outer peripheral surface 304 of the core 3 can be made constant, and forming of bubbles in the first and second insulating resins 61 and 62 when curing these can be prevented.

In the state in which the first coil 41 is formed, the plurality of bent pin members 420 are parallel to each other. The same applies to the second coil 42. Thus, the distances between the bent pin members 420 can be made constant, and forming of bubbles in the first and second insulating resins 61 and 62 when curing these can be further prevented.

As illustrated in FIGS. 5 and 6, a part of the exposed conductor portions 411a, 412a, and 410a of the first coil 41 and a part of the exposed conductor portions 421a, 422a, and 420a of the second coil 42 are positioned adjacent to the upper end surface 302 of the core 3 on one side in the axial direction. The first insulating resin 61 and the second insulating resin 62 are positioned adjacent to the upper end surface 302 of the core 3. In the axial direction of the core 3 (the Z-direction), the height of each of the first insulating resin 61 and the second insulating resin 62 is smaller than ¼ of the height H of each of the first coil 41 and the second coil 42. Thus, the amount of the first and second insulating resins 61 and 62 can be further controlled, and stress that the core receives from the first and second insulating resins 61 and 62 when magnetostriction occurs can be further reduced.

To be specific, the height h of the first insulating resin 61 is smaller than ¼ of the height H of the first coil 41, and the height h of the second insulating resin 62 is smaller than ¼ of the height H of the second coil 42. Preferably, the height H of the first coil 41 and the height H of the second coil 42 are the same, and the height h of the first insulating resin 61 and the height h of the second insulating resin 62 are the same. However, the height h of the first insulating resin 61 and the height h of the second insulating resin 62 may be independently set, and may be smaller than ¼ of the height H of the first and second coils 41 and 42 respectively corresponding to the first and second insulating resins 61 and 62.

The first insulating resin 61 covers an upper outer surface 41b of the first coil 41 on one side in the axial direction of the core 3, and the upper end surface 61a of the first insulating resin 61 is flat. The second insulating resin 62 covers an upper outer surface 42b of the second coil 42 on one side in the axial direction of the core 3, and the upper end surface 62a of the second insulating resin 62 is flat. Thus, when mounting the inductor component 1 on a mount substrate, the flat upper end surfaces 61a and 62a of the first and second insulating resins 61 and 62 can be reliably held by suction by using a suction nozzle, because the upper end surface 61a of the first insulating resin 61 and the upper end surface 62a of the second insulating resin 62 are flat. Moreover, the first and second insulating resins 61 and 62 each can be applied with a uniform amount, so that stress that the first and second insulating resins 61 and 62 applies to the core 3 due to magnetostriction can be made uniform, and variation in the L-value can be reduced.

The first insulating resin 61 does not exist on a lower outer surface 41c of the first coil 41 on the other side in the axial direction of the core 3. The second insulating resin 62 does not exist on a lower outer surface 42c of the second coil 42 on the other side in the axial direction of the core 3. Thus, stress that the core 3 receives from the first and second insulating resins 61 and 62 can be further reduced.

Preferably, the first and second insulating resins 61 and 62 cover the entirety of the conductor portions 410a and 420a of the bent pin members 410 and 420 and the conductor portions 412a and 422a of the second linear pin members 412 and 422. In this case, insulation performance can be further improved.

Preferably, the first and second insulating resins 61 and 62 are also disposed between the conductor portions 410a and 420a of the bent pin members 410 and 420 and the core 3 and between the conductor portions 412a and 422a of the second linear pin members 412 and 422 and the core 3. In this case, insulation performance between the first and second coils 41 and 42 and the core 3 can be reliably obtained. The core 3 includes a body 3a such as a ferrite and an insulating film 3b that cover the body 3a, and the core 3 is reliably insulated. However, with the configuration described above, the insulation performance between the first and second coils 41 and 42 and the core 3 can be further improved.

Preferably, the first and second insulating resins 61 and 62 are disposed, respectively in the coils 41 and 42, between the conductor portions 410a and 420a of the bent pin members 410 and 420 of adjacent turns, and between the conductor portions 412a and 422a of the second linear pin members 412 and 422 of adjacent turns. In this case, short circuit in the respective coils 41 and 42 (rare short-circuit) can be prevented, and insulation performance between adjacent turns can be reliably obtained.

Preferably, the first and second insulating resins 61 and 62 cover the conductor portions 410a and 420a of the bent pin members 410 and 420 and the conductor portions 412a and 422a of the second linear pin members 412 and 422, and continuously cover a portion of the core 3 from the upper end surface 302 to a part the inner peripheral surface 303 and the outer peripheral surface 304. In this case, the conductor portion and the core 3 are fixed, and collision of the conductor portion and the core 3 due to vibration can be prevented.

Method of Manufacturing Inductor Component

Next, a method of manufacturing the inductor component 1 will be described.

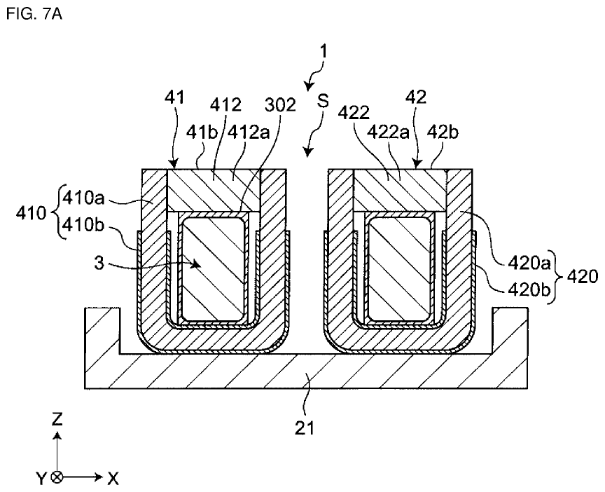

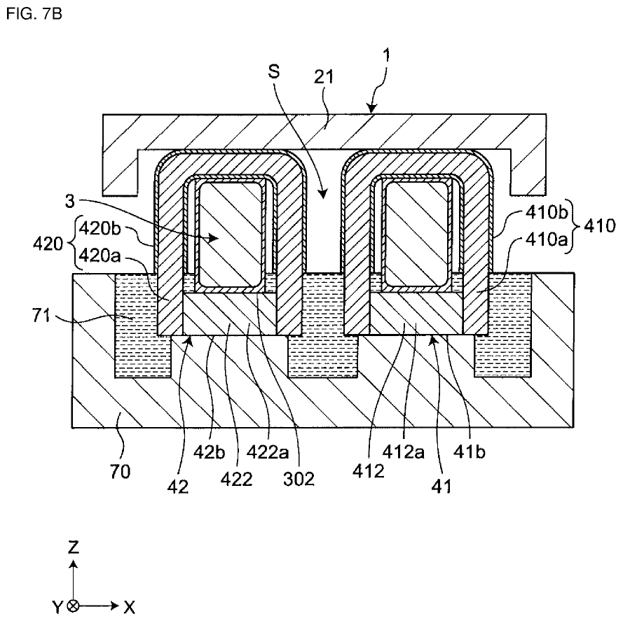

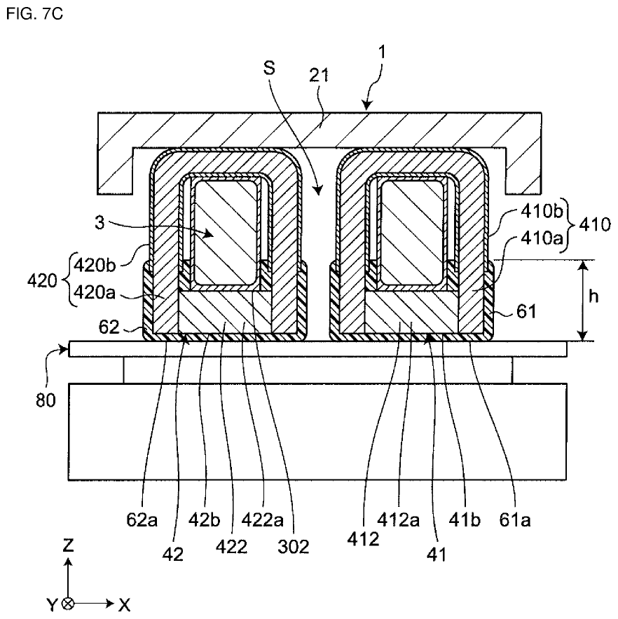

As illustrated in FIG. 7A, the first coil 41 and the second coil 42 are wound around the core 3 so that the winding axes thereof are parallel to each other, and at least a part of the exposed conductor portions 411a, 412a, and 410a of the first coil 41 and at least a part of the exposed conductor portions 421a, 422a, and 420a of the second coil 42 are disposed adjacent to the upper end surface 302 of the core 3. At this time, the core 3, the first coil 41, and the second coil 42 are attached to the bottom plate portion 21.

Subsequently, as illustrated in FIG. 7B, with the upper end surface 302 of the core 3 facing downward, at least a part of the exposed conductor portions 411a, 412a, and 410a of the first coil 41 and at least a part of the exposed conductor portions 421a, 422a, and 420a of the second coil 42 are immersed in a resin bath 70. The resin bath 70 is filled with a liquid resin 71. The resin 71 is a thermosetting resin. At this time, the first coil 41 and the second coil 42 are immersed in the resin bath 70 while being positioned so that the resin 71 adheres to portions of the first coil 41 and the second coil 42 below a predetermined height (that is, a height smaller than ¼ of the height H of the coil).

Subsequently, as illustrated in FIG. 7C, while keeping the upper end surface 302 of the core 3 facing downward, by heat curing the resin 71, which has adhered to at least a part of the exposed conductor portions 411a, 412a, and 410a of the first coil 41 and at least a part of the exposed conductor portions 421a, 422a, and 420a of the second coil 42, the first insulating resin 61 is formed on at least a part of the exposed conductor portions 411a, 412a, and 410a of the first coil 41 and the second insulating resin 62 is formed on at least a part of the exposed conductor portions 421a, 422a, and 420a of the second coil 42. At this time, the first coil 41 and the second coil 42 are heated while shedding an excess of the resin 71 adhered thereto. Heating is performed on a heating device 80 such as an oven or a hot plate. The upper end surfaces 61a and 62a of the first and second insulating resins 61 and 62 can be processed to be flat, because the heating surface of the heating device 80 is flat.

The first insulating resin 61 and the second insulating resin 62, which are not connected but separated in the space S between the first coil 41 and the second coil 42, may be manufactured in the manufacturing process by performing control so that the first and second insulating resins 61 and 62 are not connected but separated in the space S. Although the resin 71 adheres to the upper end surface 302 of the transversal portion 32 the core 3, the resin 71 may be removed so that the first insulating resin 61 and the second insulating resin 62 are not connected on the upper end surface 302, or the resin 71 may be left as it is so that the manufacturing process is simplified.

Subsequently, as illustrated in FIG. 4, the inductor component 1 is manufactured by placing the cover 22 over the core 3 and the first and second coils 41 and 42 and accommodating these in the case 2.

With the method of manufacturing the inductor component 1, only a portion that needs to be insulated can be insulated with the first and second insulating resins 61 and 62, and the amount of the first and second insulating resins 61 and 62 can be controlled. Accordingly, stress that the core 3 receives from the first and second insulating resins 61 and 62 when magnetostriction occurs can be reduced.

### Second Embodiment

Next, an inductor component according to a second embodiment will be described. In the inductor component according to the second embodiment, the first and second insulating resins may be connected in the space between the first coil and the second coil, in contrast to the inductor component according to the first embodiment. In other respects, the second embodiment is the same as the first embodiment.

To be specific, the inductor component according to the second embodiment includes an annular core, a first coil and a second coil that are wound around the core so that the winding axes thereof are parallel to each other, the first coil and the second coil each including a conductor portion and a coating the covers the conductor portion, a first insulating resin that covers at least a part of the conductor portion that is exposed from the coating of the first coil, and a second insulating resin that covers at least a part of the conductor portion that is exposed from the coating of the second coil. A part of the exposed conductor portion of the first coil and a part of the exposed conductor portion of the second coil are positioned adjacent to an upper end surface of the core on one side in the axial direction of the core. The first insulating resin and the second insulating resin are positioned adjacent to an upper end surface on one side in the axial direction of the core. In the axial direction of the core, the height of the first insulating resin and the second insulating resin is smaller than ¼ of the height of the first coil and the second coil.

Thus, only a portion that needs to be insulated can be insulated with the first and second insulating resins, and the amount of the first and second insulating resins can be controlled, because the height of the first insulating resin and the second insulating resin is smaller than ¼ of the height of the first coil and the second coil in the axial direction of the core. Accordingly, stress that the core receives from the first and second insulating resins when magnetostriction occurs can be reduced.

A method of manufacturing the inductor component according to the second embodiment is similar to the method of manufacturing the inductor component according to the first embodiment.

The present disclosure is not limited to the embodiments described above, and may be modified within the spirit and scope of the present disclosure. For example, features of the first and second embodiments may be combined in various ways as appropriate. The shape of the case and the shape of the core are not limited to those in the present embodiment, and may be modified. The number of coils is not limited to that in the embodiment described above, and may be changed.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An inductor component comprising:
an annular core;
a first coil and a second coil that are wound around the core so that winding axes thereof are parallel to each other, the first coil and the second coil each including a conductor portion and a coating that covers the conductor portion;
a first insulating resin that covers at least a part of the conductor portion of the first coil, the part being exposed from the coating; and
a second insulating resin that covers at least a part of the conductor portion of the second coil, the part being exposed from the coating,
wherein the first insulating resin and the second insulating resin are separated from each other in a space between surfaces of the first coil and the second coil that face each other.

2. The inductor component according to claim 1, wherein
the exposed part of the conductor portion of the first coil and the exposed part of the conductor portion of the second coil are positioned adjacent to an end surface of the core on one side in an axial direction of the core,
wherein
the first insulating resin and the second insulating resin are positioned adjacent to the end surface of the core on the one side in the axial direction of the core, and
in the axial direction of the core, a height of each of the first insulating resin and the second insulating resin is smaller than ¼ of a height of a corresponding one of the first coil and the second coil.

3. An inductor component comprising:
an annular core;
a first coil and a second coil that are wound around the core so that winding axes thereof are parallel to each other, the first coil and the second coil each including a conductor portion and a coating that covers the conductor portion;
a first insulating resin that covers at least a part of the conductor portion of the first coil, the part being exposed from the coating; and
a second insulating resin that covers at least a part of the conductor portion of the second coil, the part being exposed from the coating,
wherein
the exposed part of the conductor portion of the first coil and the exposed part of the conductor portion of the second coil are positioned adjacent to an end surface of the core on one side in an axial direction of the core,
the first insulating resin and the second insulating resin are positioned adjacent to the end surface of the core on the one side in an axial direction of the core, and
in the axial direction of the core, a height of each of the first insulating resin and the second insulating resin is smaller than ¼ of a height of a corresponding one of the first coil and the second coil.

4. The inductor component according to claim 1, wherein
the first insulating resin covers an outer surface of the first coil on one side in an axial direction of the core,
an end surface of the first insulating resin on one side in the axial direction of the core is flat,
the second insulating resin covers an outer surface of the second coil on one side in the axial direction of the core, and
an end surface of the second insulating resin on one side in the axial direction of the core is flat.

5. The inductor component according to claim 2, wherein
the first insulating resin covers an outer surface of the first coil on one side in an axial direction of the core,
an end surface of the first insulating resin on one side in the axial direction of the core is flat,
the second insulating resin covers an outer surface of the second coil on one side in the axial direction of the core, and
an end surface of the second insulating resin on one side in the axial direction of the core is flat.

6. The inductor component according to claim 3, wherein
the first insulating resin covers an outer surface of the first coil on one side in an axial direction of the core,
an end surface of the first insulating resin on one side in the axial direction of the core is flat,
the second insulating resin covers an outer surface of the second coil on one side in the axial direction of the core, and
an end surface of the second insulating resin on one side in the axial direction of the core is flat.

7. The inductor component according to claim 1, wherein
the first insulating resin is absent from an outer surface of the first coil on the other side in the axial direction of the core, and
wherein the second insulating resin is absent from an outer surface of the second coil on the other side in the axial direction of the core.

8. The inductor component according to claim 2, wherein
the first insulating resin is absent from an outer surface of the first coil on the other side in the axial direction of the core, and
wherein the second insulating resin is absent from an outer surface of the second coil on the other side in the axial direction of the core.

9. The inductor component according to claim 3, wherein
the first insulating resin is absent from an outer surface of the first coil on the other side in the axial direction of the core, and
wherein the second insulating resin is absent from an outer surface of the second coil on the other side in the axial direction of the core.

10. The inductor component according to claim 4, wherein
the first insulating resin is absent from an outer surface of the first coil on the other side in the axial direction of the core, and
wherein the second insulating resin is absent from an outer surface of the second coil on the other side in the axial direction of the core.

11. The inductor component according to claim 5, wherein
the first insulating resin is absent from an outer surface of the first coil on the other side in the axial direction of the core, and
wherein the second insulating resin is absent from an outer surface of the second coil on the other side in the axial direction of the core.

12. The inductor component according to claim 6, wherein
the first insulating resin is absent from an outer surface of the first coil on the other side in the axial direction of the core, and
wherein the second insulating resin is absent from an outer surface of the second coil on the other side in the axial direction of the core.

13. A method of manufacturing an inductor component, comprising:
winding a first coil and a second coil around an annular core so that winding axes thereof are parallel to each other and disposing at least a part of a conductor portion of the first coil, the part being exposed from the coating, and at least a part of a conductor portion of the second coil, the part being exposed from the coating, adjacent to an end surface of the core on one side in an axial direction;
immersing at least a part of the exposed conductor portion of the first coil and at least a part of the exposed conductor portion of the second coil into a resin bath, with the end surface of the core facing downward; and
forming a first insulating resin on at least the part of the exposed conductor portion of the first coil by heat curing a resin that has adhered to at least the part of the exposed conductor portion of the first coil, and forming a second insulating resin on at least the part of the exposed conductor portion of the second coil by heat curing a resin that has adhered to the at least the part of the exposed conductor portion of the second coil, while keeping the end surface of the core facing downward.
